(19) United States
(12) Patent Application Publication
(10) Pub. No.: US 2023/0081507 A1
(43) Pub. Date: Mar. 16, 2023

(54) SYSTEMS AND METHODS FOR LIVE FISH TISSUE PRESERVATION

(71) Applicant: Finless Foods Inc., Emeryville, CA (US)

(72) Inventors: Brian Wyrwas, Oakland, CA (US); I-Hsiung Brandon Chen, San Diego, CA (US)

(21) Appl. No.: 17/800,932

(22) PCT Filed: Feb. 23, 2021
(86) PCT No.: PCT/US2021/019210

§ 371 Date: Aug. 19, 2022

Related U.S. Application Data
(60) Provisional application No. 62/981,829, filed on Feb. 26, 2020.

(51) Int. Cl. A01N 1/02; A23B 4/28

(52) U.S. Cl. CPC A01N 1/021; A01N 1/0242; A23B 4/28; A23V 2002/00

(57) ABSTRACT

The present disclosure describes systems, devices, compositions, and methods for live tissue preservation.

### CROSS REFERENCE TO RELATED APPLICATION

This application claims the benefit of U.S. Application No. 62/981,829 filed on Feb. 26, 2020, the disclosure of which is hereby incorporated by reference in its entirety.

### BACKGROUND

Preserving fish tissue during transportation on a commercial scale is difficult. Unfortunately, transportation of fish typically damages or kills fish tissue, which leads to inferior products compared to fresh tissue products. Although fish can be frozen or transported in tanks full of water sparged with oxygen, tissue viability during transport times remains marginal at best.

### SUMMARY

The present invention recognizes a need for improved systems, compositions, and methods for live tissue preservation. Among other things, the present disclosure recognizes that preserving tissue such as fish tissue during transport improves the quality of the tissue. For example, in some embodiments, the present disclosure recognizes that perfusing live fish tissue during transport, rather than freezing the tissue or transporting live fish in tanks full of water sparged with oxygen, improves the quality of the fish tissue while minimizing costs.

Among other things, the present disclosure recognizes that freezing fish tissue on a commercial scale substantially kills all live cells and/or damages the tissues, which leads to an inferior product after thawing as compared to fresh tissue. As another example, the present disclosure recognizes that even without freezing, live cells during transportation die at an accelerated rate due to lack of factors such as oxygen and nutrients. For instance, in some embodiments, the present disclosure recognizes that depriving tissue of factors such as oxygen and nutrients triggers tissue breakdown, thereby leading to inferior products (e.g., to the point of inedibility).

Among other things, the present disclosure recognizes that transporting live fish in full tanks of water sparged with oxygen can physically damage the fish over travel durations longer than thirty minutes. Such restrictions require heavy transport weights that increase costs and often limit the number of fish that can be transported in such a fashion.

Among other things, in some embodiments, the present disclosure provides systems, compositions, devices, and methods for live fish tissue preservation during transportation and/or preservation. For example, the present disclosure provides particular systems, compositions, devices, and methods of transporting and/or preserving live fish tissue and/or preventing tissue damage to live fish tissue by contacting live fish tissue with a fluid via a needle having been placed into an organ of a circulatory system of one or more fish, including, for instance, with reference to systems, methods, and devices specifically exemplified herein.

In some embodiments, a fluid suitable for contacting and/or perfusing and/or storing live fish cells, tissues, or organs in accordance with the systems, compositions, methods, and/or devices exemplified herein.

In some embodiments, a needle is placed into an organ of a circulatory system for receiving a fluid for perfusing a circulatory system.

Among other things, the present invention further provides for systems, methods, compositions, and devices in preserving cell, tissue and organs for fish in research and/or commercial settings where viable cell, organ and other culture techniques are needed for basic and applied biomedical research and/or diagnostic procedures and/or food-related industries requiring preserving tissue viability in vitro.

Elements of embodiments involving one aspect of the invention (e.g., methods) can be applied in embodiments involving other aspects of the invention, and vice versa.

### BRIEF DESCRIPTION OF THE DRAWING

FIGS. 1A-1C depicts a system for transporting and/or preserving live fish tissue and/or preventing tissue damage to live fish tissue, in accordance with an embodiment of the present disclosure.

FIGS. 2A-2C depicts a system for transporting and/or preserving live fish tissue and/or preventing tissue damage to live fish tissue, in accordance with an embodiment of the present disclosure.

FIG. 3 depicts a system for transporting and/or preserving live fish tissue and/or preventing tissue damage to live fish tissue, in accordance with an embodiment of the present disclosure.

FIG. 4 is a block diagram of an exemplary cloud computing environment, used in certain embodiments.

FIG. 5 is a block diagram of an exemplary computing device and an example mobile computing device used in certain embodiments.

FIG. 6 depicts a schematic of a body cavity of a fish, including arteries, veins, and other organs, in accordance with an embodiment of the present disclosure.

### DEFINITIONS

“About”: The term “about”, when used herein in reference to a value, refers to a value that is similar, in context to the referenced value. In general, those skilled in the art, familiar with the context, will appreciate the relevant degree of variance encompassed by “about” in that context. For example, in some embodiments, the term “about” may encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or less of the referred value.

“Amino acid”: in its broadest sense, as used herein, refers to any compound and/or substance that can be incorporated into a polypeptide chain, e.g., through formation of one or more peptide bonds. In some embodiments, an amino acid has the general structure H₂N-C(H)(R)-COOH. In some embodiments, an amino acid is a naturally-occurring amino acid. In some embodiments, an amino acid is a non-natural amino acid; in some embodiments, an amino acid is a D-amino acid; in some embodiments, an amino acid is an L-amino acid. “Standard amino acid” refers to any of the twenty standard L-amino acids commonly found in naturally occurring peptides. “Nonstandard amino acid” refers to any amino acid, other than the standard amino acids, regardless of whether it is prepared synthetically or obtained from a natural source. In some embodiments, an amino acid, including a carboxy- and/or amino-terminal amino acid in a polypeptide, can contain a structural modification as compared with the general structure above. For example, in some embodiments, an amino acid may be modified by methylation, amidation, acetylation, pegylation, glycosylation, phosphorylation, and/or substitution (e.g., of the amino group, the carboxylic acid group, one or more protons, and/or the hydroxyl group) as compared with the general structure. In some embodiments, such modification may, for example, alter the circulating half-life of a polypeptide containing the modified amino acid as compared with one containing an otherwise identical unmodified amino acid. In some embodiments, such modification does not significantly alter a relevant activity of a polypeptide containing the modified amino acid, as compared with one containing an otherwise identical unmodified amino acid. As will be clear from context, in some embodiments, the term “amino acid” may be used to refer to a free amino acid; in some embodiments it may be used to refer to an amino acid residue of a polypeptide.

“Buffer”: The term “buffer,” as used herein, refers to aqueous solutions or compositions that resist changes in pH when acids or bases are added to the solution. Solutions that exhibit buffering activity are often referred to in the art as “buffers” or “buffer solutions.” Buffers typically are able to maintain the pH of the solution within defined ranges, often for example between pH 5.5 and pH 7.5. Buffer solutions that are typically able to maintain a pH of approximately 7, are often referred to a “physiological buffers.” Exemplary biological buffers include, but are not limited to, Lactated Ringer’s solution, physiological saline solution, N-(2-Acetamido)-2-aminoethanesulfonic acid (ACES); N-2-acetamido-2-iminodiacetic acid (ADA); N,N-bis(2-hydroxyethyl)-2-aminoethanesulfonic acid (BES); N,N-bis(2-hydroxyethyl)glycine (BICINE); 2-bis(2-hydroxyethyl)amino-2-(hydroxymethyl)-1,3-propanediol (BIS-TRIS); 3-(cyclohexylamino)-1-propanesulfonic acid (CAPS); 3-(cyclohexylamino)-2-hydroxy-1-propanesulfonic acid (CAPSO); 2-(cyclohexylamino)ethanesulfonic acid (CHES); (N,N-bis[2-hydroxyethyl]amino)-2-hydroxypropanesulfonic acid (DIPSO); 4-(2-Hydroxyethyl)-1-piperazinepropanesulfonic acid (EPPS); 4-(2-hydroxyethyl)piperazine-1-ethanesulfonic acid (HEPES); 4-(2-hydroxyethyl)piperazine-1-(2-hydroxypropane sulfonic acid) (HEPPSO); 2-(N-morphilino)ethanesulfonic acid (MES); 3-(N-morpholino)propanesulfonic acid (MOPS); 3-morpholino-2-hydroxypropanesulfonic acid (MOPSO); piperazine-1,4-bis(2-ethanesulfonic acid) (PIPES); piperazine-N,N′-bis(2-hydroxypropane sulfonic acid) (POPSO); [(2-hydroxy-1,1-bis(hydroxy methyl)ethyl)amino]-1-propanesulfonic acid (TAPS); 3-(N-tris[hydroxymethyl]methylamino)-2-hydroxypropanesulfonic acid (TAPSO); 2-[(2-hydroxy-1,1-bis(hydroxylmethyl)ethyl)amino]ethanesulfonic acid (TES); N-[tris(hydroxymethyl)methyl]glycine (TRICINE); and tris(hydroxymethyl)aminomethane) (TRIS); mixtures or derivatives thereof, as well as other biological buffers including those developed by Good et al. (1966).

“Comparable”: As used herein, the term “comparable” refers to two or more agents, entities, situations, sets of conditions, etc., that may not be identical to one another but that are sufficiently similar to permit comparison therebetween so that one skilled in the art will appreciate that conclusions may reasonably be drawn based on differences or similarities observed. In some embodiments, comparable sets of conditions, circumstances, individuals, or populations are characterized by a plurality of substantially identical features and one or a small number of varied features. Those of ordinary skill in the art will understand, in context, what degree of identity is required in any given circumstance for two or more such agents, entities, situations, sets of conditions, etc. to be considered comparable. For example, those of ordinary skill in the art will appreciate that sets of circumstances, individuals, or populations are comparable to one another when characterized by a sufficient number and type of substantially identical features to warrant a reasonable conclusion that differences in results obtained or phenomena observed under or with different sets of circumstances, individuals, or populations are caused by or indicative of the variation in those features that are varied.

“Comprising”: A composition or method described herein as “comprising” one or more named elements or steps is open-ended, meaning that the named elements or steps are essential, but other elements or steps may be added within the scope of the composition or method. To avoid prolixity, it is also understood that any composition or method described as “comprising” (or which “comprises”) one or more named elements or steps also describes the corresponding, more limited composition or method “consisting essentially of” (or which “consists essentially of”) the same named elements or steps, meaning that the composition or method includes the named essential elements or steps and may also include additional elements or steps that do not materially affect the basic and novel characteristic(s) of the composition or method. It is also understood that any composition or method described herein as “comprising” or “consisting essentially of” one or more named elements or steps also describes the corresponding, more limited, and closed-ended composition or method “consisting of” (or “consists of”) the named elements or steps to the exclusion of any other unnamed element or step. In any composition or method disclosed herein, known or disclosed equivalents of any named essential element or step may be substituted for that element or step.

“Fluid”: The term “fluid” as are used herein in a broad sense is intended to encompass a variety of solutions, buffers, formulations, and/or compounds, in which a specific biological organism, cell, tissue, organ, or other type of biological samples or materials may reside for any period of time that is conducive to the preservation of viability of the biological material placed within such buffers, solutions, formulations, and/or compounds.

“Improve,” “increase”, “inhibit” or “reduce”: As used herein, the terms “improve”, “increase”, “inhibit’, “reduce”, or grammatical equivalents thereof, indicate values that are relative to a baseline or other reference measurement. In some embodiments, an appropriate reference measurement may be or comprise a measurement in a particular system (e.g., in a single individual) under otherwise comparable conditions absent presence of (e.g., prior to and/or after) a particular agent or treatment, or in presence of an appropriate comparable reference agent. In some embodiments, an appropriate reference measurement may be or comprise a measurement in comparable system known or expected to respond in a particular way, in presence of the relevant agent or treatment.

“Perfusion” and/or “Perfusing”: As used herein, the terms “perfusion” and/or “perfusing” refers to the passage (or passaging) of blood, a blood substitute, or other fluid through the blood vessels or other natural channels in an organ or tissue.

“Substantially”: As used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

“Tissue” and/or “Organ”: As used herein, the term, “tissue” and/or “organ” refers to viable cellular materials in an aggregate form, e.g., small portions of an organ, as well as dispersed cells, e.g., cells dispersed, isolated and/or grown from muscle, heart muscle, liver or kidney, including bone marrow cells and progeny cells, blood born stem cells and progeny, and the various other blood elements, unless otherwise specified. In some embodiments, the tissue and/or organ refers to kidney, heart liver, stomach, spleen, pancreas, lung, brain, eye, intestines, bladder, skin or dermal tissue, blood vessel, veins, arteries, heart valves, sperm, and oocyte(s). As used herein, the term “organ” encompasses both solid organs, e.g., kidney, heart, liver, lung, as well as functional parts of organs, e.g., segments of skin, sections of artery, veins, transplantable lobes of a liver, kidney, lung, and the like.

### DETAILED DESCRIPTION OF CERTAIN EMBODIMENTS

The present invention provides methods, compositions, systems, and devices for transporting and/or preserving live fish tissue and/or preventing tissue damage to live fish tissue.

Among other things, in some embodiments, the present invention improves the ability to transport live fish tissue while the brain of the fish is no longer functioning. Among other things, in some embodiments, one advantage of the present invention includes decreasing weight of the transported unit as compared to traditional methods of live fish transport. Another example of an advantage of the present invention is that the fish can be transported for an increased amount of time. For example, transportation can be increased from a couple of days to a couple of weeks or months or more. Among other things, the present invention allows for temperature of the transported unit to not be at extremely low levels, thereby reducing costs on cooling. Among other things, the present invention increases the perceived freshness to the consumer due to reduce tissue breakdown via necrosis.

### Fish

The present invention provides for a variety of fish that can be used in accordance with the systems, methods, devices, and fluids exemplified herein. As exemplified herein, the present invention provides systems, compositions, and methods to transport all types of fish and is not limited to transporting fish that can only survive traditional transportation methods. In some embodiments, fish include teleosts, primitive bichirs, sturgeons, paddlefish, freshwater garfishes, or bowfins. In some embodiments, fish include fish listed in “Appendix: List of Fish” as described by https://en.wiktionary.org/wiki/Appendix:List_of_fish, the contents of which is hereby incorporated by reference in its entirety.

### Reducing Stress Experienced by Fish

Among other things, the present invention provides for a variety of systems, methods, and devices for reducing and/or mitigating stress one or more fish experiences using any of the systems, methods, or devices exemplified herein. In some embodiments, stress experienced by fish can promote tissue damage and/or necrosis which can lead to poor product quality. In some embodiments, methods and compositions for improving fish product quality is described by U.S. Pat. No. 6,001,396A, the contents of which is hereby incorporated by reference in its entirety. In some embodiments, methods and compositions for improving fish product quality is described by U.S. Pat. No. 9,468,197B2, the contents of which is hereby incorporated by reference in its entirety.

### Temperature

In some embodiments, fish freeze at or below 0° C. In some embodiments, fish freeze at or below -4° C. in salt water.

In some embodiments, one or more fish can be cooled to a temperature to reduce and/or eliminate stress perceived by the fish. In some embodiments, one or more fish has a temperature that is in a range from about -4° C. to about 20° C. In some embodiments, one or more fish are cooled to have a temperature of about 20° C. In some embodiments, one or more fish are cooled to have a temperature of about 19° C. In some embodiments, one or more fish are cooled to have a temperature of about 18° C. In some embodiments, one or more fish are cooled to have a temperature of about 17° C. In some embodiments, one or more fish are cooled to have a temperature of about 16° C. In some embodiments, one or more fish are cooled to have a temperature of about 15° C. In some embodiments, one or more fish are cooled to have a temperature of about 14° C. In some embodiments, one or more fish are cooled to have a temperature of about 13° C. In some embodiments, one or more fish are cooled to have a temperature of about 12° C. In some embodiments, one or more fish are cooled to have a temperature of about 11° C. In some embodiments, one or more fish are cooled to have a temperature of about 10° C. In some embodiments, one or more fish are cooled to have a temperature of about 9° C. In some embodiments, one or more fish are cooled to have a temperature of about 8° C. In some embodiments, one or more fish are cooled to have a temperature of about 7° C. In some embodiments, one or more fish are cooled to have a temperature of about 6° C. In some embodiments, one or more fish are cooled to have a temperature of about 5° C. In some embodiments, one or more fish are cooled to have a temperature of about 4° C. In some embodiments, one or more fish are cooled to have a temperature of about 3° C. In some embodiments, one or more fish are cooled to have a temperature of about 2° C. In some embodiments, one or more fish are cooled to have a temperature of about 1° C. In some embodiments, one or more fish are cooled to have a temperature of about 0° C. In some embodiments, one or more fish are cooled to have a temperature of about -1° C. In some embodiments, one or more fish are cooled to have a temperature of about -2° C. In some embodiments, one or more fish are cooled to have a temperature of about -3° C. In some embodiments, one or more fish are cooled to have a temperature of about -4° C.

Among other things, in some embodiments, the present invention describes systems, methods, compositions, and devices for reducing stress of one or more fish. In some embodiments, one or more fish can be placed in an ice bath to reduce stress. In some embodiments, one or more fish can be placed in a cold water bath to reduce stress. In some embodiments, one or more fish can be placed in a refrigerator to reduce stress. In some embodiments, one or more fish can be placed in an ice-water slurry bath to reduce stress. In some embodiments, an ice-water slurry bath comprises about 0.1% to about 99% ice by weight. In some embodiments, ice can be crushed. In some embodiments, ice can be cubed. In some embodiments, ice can be shaved. In some embodiments, ice can be flaked-shaped. In some embodiments, ice can be pear-shaped. In some embodiments, ice can be crescent-shaped. In some embodiments, a cooling process that be used as an embodiment of the present invention is described in U.S. Pat. No. 9,468,197B2, the disclosure of which is hereby incorporated by reference in its entirety.

### Antioxidants

Among other things, the present disclosure describes methods, systems, compositions, and/or devices that comprise exposing a fish to an antioxidant to reduce stress to the fish and/or enhance the quality of the fish and/or preserve the cells, tissues, and/or organs of the fish. In some embodiments, the fluid comprises an antioxidant such as a tocopherol. In some embodiments, the fluid comprises an antioxidant such as an ethoxyquin. In some embodiments, the fluid comprises an antioxidant such as butylated hydroxytoluen (BHT). In some embodiments, the fluid comprises an antioxidant such as butylated hydroxyanisole (BHA). In some embodiments, the fluid comprises an antioxidant such as a tert-Butylhydroquinone (TBHG). In some embodiments, the fluid comprises an antioxidant such as a carotenoid. In some embodiments, the fluid comprises an antioxidant such as a retinoid.

Among other things, in some embodiments, the present disclosure describes methods, systems, compositions and/or devices for reducing potential oxygen damage to live fish tissue. Examples of methods, systems, compositions and/or devices are described by U.S. Pat. No. 8,268,547B2, the contents of which is hereby incorporated by reference in its entirety.

### Incapacitating Fish

In some embodiments, the present invention does not require for one or more fish to be incapacitated.

Among other things, the present invention provides for a variety of systems, methods, and devices for incapacitating one or more fish as exemplified herein. In some embodiments, one or more fish are incapacitated via asphyxiation. In some embodiments, one or more fish are incapacitated via an ice bath. In some embodiments, one or more fish are incapacitated via decapitation. For example, in some embodiments, decapitation is performed using a knife, using a hydraulic press attached to a sharp edge, or using a saw (e.g., a circular saw, e.g., a reciprocating saw). In some embodiments, one or more fish are incapacitated via one or more blows to the head.

In some embodiments, one or more fish are incapacitated using a hammer, axe, knife, scissors, or jig saw as described herein. In some embodiments, one or more fish are incapacitated using electrical power, human strength, steam power or gas power.

In some embodiments, one or more fish are incapacitated via one or more blows to the head using a hammer. Types of hammers include a ball peen hammer, a claw hammer, a club hammer, a dead blow hammer, a framing hammer, a sledge hammer, a tack hammer, a brick hammer, an electrician’s hammer, an engineering hammer, a rock hammer, a scutch hammer, a shingle hammer, a spike maul hammer, a soft-faced hammer, a toolmaker’s hammer, a welding hammer, or a power hammer. In some embodiments, a power hammer can include a steam-powered hammer, an electrical powered hammer, or an air powered hammer. In some embodiments, a hammer can be a rubber hammer, a metal hammer, a plastic hammer, a wooden hammer, a brass hammer, or a copper hammer.

In some embodiments, one or more fish are incapacitated via one or more blows to the head using an axe. Types of axes include a felling axe, a hatchet, a throwing tomahawk, a splitting axe, a double bit axe, a Viking or dane axe, a tactical axe, a battle axe, a hewing axe, a carpenter’s axe, a fireman’s axe, a crash axe or a throwing axe. In some embodiments, an axe can be a rubber axe, a metal axe, a plastic axe, a brass axe, or a copper axe.

In some embodiments, one or more fish are incapacitated via pithing as exemplified herein. In some embodiments, one or more fish are pithed with a metal material. In some embodiments, one or more fish are pithed with an alloy material. In some embodiments, one or more fish are pithed with a rubber material. In some embodiments, one or more fish are pithed with a plastic material. In some embodiments, one or more fish are pithed with a wooden material. In some embodiments, one or more fish are pithed with a brass material. In some embodiments, one or more fish are pithed with a copper material. In some embodiments, one or more fish are pithed with a carbon fiber material. In some embodiments, one or more fish are pithed using a material having a diameter from about 1 mm to about 15 cm.

In some embodiments, one or more fish are pithed in the brain (e.g., in the olfactory lobe, e.g., in the telencephalon, e.g., in the optic lobe, e.g., in the cerebellum, e.g., in the myelencephalon, e.g., in the spinal cord). In some embodiments, one or more fish are pithed in the spinal cord (e.g., such that the nervous system is destroyed, e.g., such that nerves are destroyed). In some embodiments, the tail of one or more fish are cut to gain access to the spinal cord (e.g., through any cut/opening on the posterior side of the fish) (e.g., through any cut/opening on the anterior side of the fish). In some embodiments, access to the spinal cord is obtained through an opening to the brain. In some embodiments, one or more fish are pithed in the heart. In some embodiments, one or more fish are pithed in the gills (e.g., at the base of the gills, e.g., at the top of the gills, e.g., at the top of the gills near the front of the one or more fish, e.g., at the middle of the gills).

Among other things, in some embodiments, one or more fish are incapacitated using ikejime as described herein. Ikejime or Ikijime is a humane method of killing fish to maintain the quality of its meat. In some embodiments, ikejime involves the insertion of a spike quickly into the hindbrain or other organ of a fish (e.g., wherein the hindbrain and/or other organ is located slightly behind and above the eye, thereby causing immediate brain death). In some embodiments, ikejime involves insertion of a spike directly into the hindbrain or other organ of a fish (e.g., wherein the hindbrain and/or other organ is located slightly behind and above the eye, thereby causing immediate brain death). In some embodiments, when spiked correctly, fish fins flare. In some embodiments, when spiked correctly, fish relax. In some embodiments, when spiked correctly, fish immediately ceasing all motion. Among other things, in some embodiments, destroying brain and spinal cord of fish may prevent reflex action from happening. In some embodiments, such muscle movements may otherwise consume adenosine triphosphate in the muscle, which may produce lactic acid and ammonia (e.g., making fish sour, soggy and/or less tasteful). Furthermore, in some embodiments, the present disclosure describes that blood contained in fish flesh retracts to the gut cavity, which, for example, may produce a better colored and flavored fillet. In some embodiments, the present disclosure describes that blood contained in fish flesh retracts to the gut cavity, which, for example, may prolong shelf life. As described herein, ikejime may be considered to be a fastest and humane method of killing fish. For example, ikejime-killed fish is sought-after by restaurants as it also allows the fish to develop more umami when aged. Among other things, the present invention describes using ikejime as exemplified herein. In some embodiments, ikejime is used to pith the nervous system (e.g., to stop neurons from firing).

Among other things, in some embodiments, one or more fish are incapacitated by poisoning. In some embodiments, poisoning is performed by saturating water with carbon dioxide (e.g., wherein carbon dioxide is introduced in a range greater than 5 mg/L, e.g., greater than 10 mg/L). In some embodiments, poisoning is performed by introducing tricaine mesylate (MS222) as described by https://en.wikipedia.org/wiki/Tricaine_mesylate, the contents of which is hereby incorporated by reference in its entirety. It is noted that MS222 would not be used in embodiments where the one or more fish are to be consumed by humans.

Among other things, in some embodiments, one or more fish are incapacitated by electricity.

### Introducing and/or Removing Fluid Into and/or From the Circulatory System

The present invention provides methods, systems, and devices for live fish transporting and/or preserving live fish tissue and/or preventing tissue damage to live fish tissue. Among other things, the present invention describes introducing fluid into the circulatory system of one or more fish using any of the methods, systems, and/or devices exemplified herein.

### Needles

Among other things, in some embodiments, the present invention provides methods, systems, and devices for live fish transporting and/or preserving live fish tissue and/or preventing tissue damage to live fish tissue using one or more needles. In some embodiments, a needle has a NeedlePoint style such as 2, 3, 3T, 4 (at 1 degree through 90 degrees), 5, or AS. In some embodiments, a needle has a needle gauge of 7,8,9,10,11,12,13,14,15,16,17,18,19,20,21,22,23,24,25,26,27,28,29,30,31,32,or 33. In some embodiments, a needle has a material comprising medical grade stainless steel, advanced alloys, exotic metals, MRI compatible materials, or polymers.

In some embodiments, one or more needles are introduced into the heart of the one or more fish as exemplified herein. In some embodiments, a needle head is introduced into the heart of the one or more fish as exemplified herein.

In some embodiments, one needle is introduced into an organ of the circulatory system for pumping fluid into the circulatory system as exemplified herein. In some embodiments, one needle is introduced into an organ of the circulatory system for pumping fluid into and out of an organ of the circulatory system as exemplified herein. In some embodiments, a first needle is introduced into an organ of the circulatory system for pumping fluid into an organ of the circulatory system and a second needle is introduced into the circulatory system for pumping fluid out of the circulatory system as exemplified herein. In some embodiments, one needle is introduced into an organ of the circulatory system for pumping fluid simultaneously into and out of an organ of the circulatory system as exemplified herein.

In some embodiments, a needle is introduced into the heart. In some embodiments, a needle is introduced into the hepatic vein. In some embodiments, a needle is introduced into the portal vein. In some embodiments, a needle is introduced into the caudal vein. In some embodiments, a needle is introduced into the caudal artery. In some embodiments, a needle is introduced into the dorsal aorta. In some embodiments, a needle is introduced into the mesenteric artery. In some embodiments, a needle is introduced into the hepatic artery. In some embodiments, a needle is introduced into the efferent gill arteries. In some embodiments, a needle is introduced into the hepatic artery. In some embodiments, a needle is introduced into the afferent gill arteries.

### Tubes and Pumps

Among other things, in some embodiments, the present invention provides methods, systems, and devices for live fish transporting and/or preserving live fish tissue and/or preventing tissue damage to live fish tissue using a system of one or more tubes as exemplified herein. Type of tubes include aluminum, copper, steel, stainless steel, nylon, Polyethylene (PE), Polypropylene, Polyurethane, PVC, Vinyl, rubber tubing, Fiberglass and composites. In some embodiments, a back end of a needle is attached to one tube and that tube is connected to a pump for pumping fluid through the circulatory system (e.g., to perfuse the circulatory system) of one or more fish. Types of pumps include peristaltic pumps, lobe pumps, diaphragm pumps, or piston pumps.

In some embodiments, a fluid is pumped through the circulatory system of one or more fish. For example, in some embodiments, a system comprises one fish. As another example, a system comprises one or more fish.

### Closed System

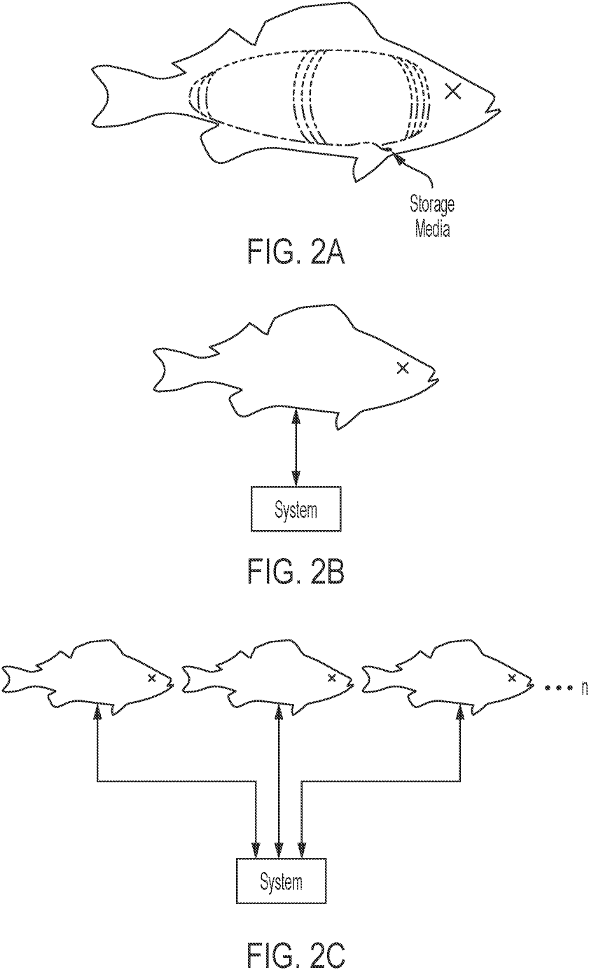

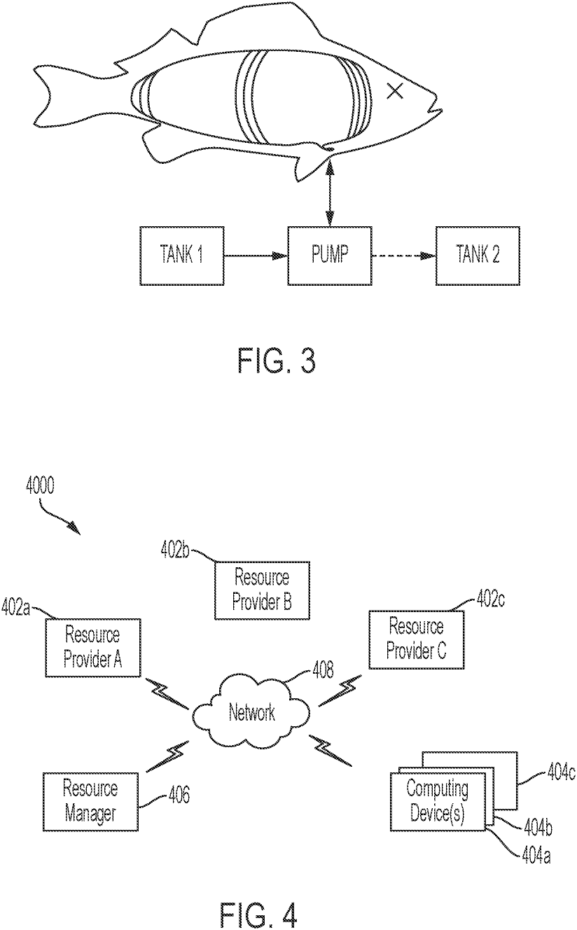

Among other things, in some embodiments, movement of fluid is within a closed system (see, for example, FIG. 2A or FIG. 3A). In some embodiments, the present disclosure provides for systems, methods, and/or devices comprising one or more tanks for storing and/or moving fluid as exemplified herein. For example, in some embodiments, fluid is depleted from a first tank, perfused through the circulatory of one or more fish, and accumulated into a second tank.

For example, in some embodiments, fluid comprises minimal negative factors that harm tissue viability. In some embodiments, fluid comprises one or more positive factors that keep and/or replenish positive factors that maintain and/or promote and/or preserve tissue viability. Types of negative factors include ammonia, acids, or toxic cell waste. Types of positive factors include water, elements to balance pH, elements to maintain osmolarity and/or osmolality, growth factors, oxygen, oxygen products, organic compounds, thickening agents, vitamins, ions, ATP, or cofactors.

### Fluid

Among other things, the present disclosure describes a variety of factors that can be used in a fluid for perfusing a circulatory system of a fish. In some embodiments, a fluid is described herein for maintaining and/or preserving fish tissue. In some embodiments, the fluid comprises spent fish blood devoid of toxic cell wastes, acids, or ammonium. In some embodiments, the fluid comprises chemically-defined pH and/or osmolality-balanced media comprising nutrients (e.g., carbon, nitrogen, or phosphate sources). In some embodiments, the fluid comprises water. In some embodiments, the fluid comprises sugars. In some embodiments, the fluid comprises elements to balance pH. In some embodiments, the fluid comprises elements to balance osmolality. In some embodiments, the fluid comprises gasses. In some embodiments, the fluid comprises organic compounds. In some embodiments, the fluid comprises salts. In some embodiments, the fluid comprises thickening agents. In some embodiments, the fluid comprises vitamins. In some embodiments, the fluid comprises growth factors. In some embodiments, the fluid comprises ions. In some embodiments, the fluid comprises ATP. In some embodiments, the fluid comprises cofactors. In some embodiments, the fluid comprises NADH/NADPH. In some embodiments, the fluid comprises buffers. In some embodiments, the fluid comprises enzymes. In some embodiments, the fluid comprises combinations of factors as exemplified herein.

Among other things, in some embodiments, as exemplified herein, the fluid comprises isotonic saline solutions, that may contain, in various proportions, salts, sugars, osmotic agents, local anesthetic, buffers, and other such agents, as described, simply by way of example, by Berdyaev et al., U.S. Pat. No. 5,432,053; Belzer et al., and the product ViaSpan®, described by U.S. Pat. Nos. 4,798,824, 4,879,283; and 4,873,230; Taylor, U.S. Pat. No. 5,405,742; Dohi et al., U.S. Pat. No. 5,565,317; Stem et al., U.S. Pat. Nos. 5,370,989 and 5,552,267, the disclosures of which are incorporated by reference in their entireties herein. The ViaSpan® product data sheet describes the product as a sterile, non-pyrogenic solution for hypothermic flushing and storage of organs. The solution has an approximate calculated osmolarity of 320 mOsM, a sodium concentration of 29 mEq/L, a potassium concentration of 125 mEq/L, and a pH of 7.4.

Among other things, in some embodiments, the fluid comprises pyruvate or inorganic salts supporting cell membrane potential such as described in U.S. Pat. No. 5,066,578, the disclosure of which is hereby incorporated by reference in its entirety. As another example, in some embodiments, the fluid comprises one or more phosphatidic acids or sugars, and lysophosphotidic acids or sugars, together with enhancers such as albumen, optionally delivered in liposomal compositions such as described by U.S. Pat. Nos. 6,495,532 and 6,004,579, the disclosures of which is hereby incorporated by reference in its entirety.

Among other things, in some embodiments, the fluid comprises compositions described by International Patent Publication No. WO1999015011A1, U.S. Pat. No. US7960098B2, International Patent Publication No. W02008100636A2, and U.S. Publication No. US20050037330A1, the contents of which is hereby incorporated by reference in their entireties.

Among other things, in some embodiments, the fluid comprises compositions as described by U.S. Pat. No. 6,001,396A, the contents of which is hereby incorporated by reference in its entirety.

Among other things, in some embodiments, the fluid comprises compositions as described by U.S. Pat. No. 8,268,547B2, the contents of which is hereby incorporated by reference in its entirety.

Among other things, in some embodiments, the fluid comprises compositions as described by U.S. Pat. No. 6,824,389B1, the contents of which is hereby incorporated by reference in its entirety.

### Water

Among other things, the present disclosure describes methods, systems, and/or devices comprising a fluid that comprises water as exemplified herein. In some embodiments, water is or comprises tap water. In some embodiments, water is or comprises mineral water. In some embodiments, water is or comprises spring water. In some embodiments, water is or comprises glacier water. In some embodiments, water is or comprises sparkling water. In some embodiments, water is or comprises distilled water. In some embodiments, water is or comprises purified water. In some embodiments, water is or comprises non-alkaline water. In some embodiments, water is or comprises well water. In some embodiments, water is or comprises ocean water. In some embodiments, water is or comprises sea water. In some embodiments, water is or comprises lake water. In some embodiments, water is or comprises sterile water. In some embodiments, water has been sterilized using an autoclave, a filter (e.g., a tangential flow filer, e.g., a PES filter, e.g., a PVDF filer, e.g., a nylon filter). In some embodiments, water is or comprises non-sterile water.

### Sugars

Among other things, the present disclosure describes methods, systems, and/or devices comprising a fluid that comprises a sugar as exemplified herein. In some embodiments, sugar is or comprises glucose. In some embodiments, sugar is or comprises fructose. In some embodiments, sugar is or comprises sucrose. In some embodiments, the fluid comprises a plurality of sugars. In some embodiments, the fluid comprises sugar in a range from about 100 mg/L to about 2000 mg/L. In some embodiments, the fluid comprises sugar in a range from about 500 mg/L to about 1500 mg/L. In some embodiments, the fluid comprises sugar in a range from about 1000 mg/L to about 1300 mg/L. In some embodiments, the fluid comprises sugar (e.g., glucose) at a concentration of about 1250 mg/L.

### Elements to Balance pH

Among other things, the present disclosure describes methods, systems, and/or devices that comprise a fluid comprising an element to balance pH. In some embodiments, the fluid comprises an element such as sodium bicarbonate. In some embodiments, the fluid comprises an element such as (4-(2-hydroxyethyl)-1-piperazineethanesulfonic acid) (HEPES). In some embodiments, the fluid comprises phosphate-buffered saline. An example of phosphate-buffered saline is described by https://en.wikipedia.org/wiki/Phosphate-buffered_saline, the contents of which is hereby incorporated by reference in its entirety. In some embodiments, the fluid comprises a plurality of elements to balance pH.

In some embodiments, the fluid comprises an element to balance pH within a range from about a pH of about 4.0 to a pH of about 9.0. In some embodiments, the fluid comprises an element to balance pH within a range from about a pH of about 5.0 to a pH of about 8.0. In some embodiments, the fluid comprises an element to balance pH within a range from about a pH of about 6.0 to a pH of about 8.0. In some embodiments, the fluid comprises an element to balance pH within a range from about a pH of about 7.2 to a pH of about 7.2. In some embodiments, the pH is as described by https://www.intechopen.com/books/biomedical-tissue-culture/culture-conditions-and-types-of-growth-media-for-mammalian-cells, the contents of which is hereby incorporated by reference in its entirety.

### Elements to Maintain Osmolality

Among other things, the present disclosure describes methods, systems, and/or devices that comprise a fluid comprising an element to maintain osmolality (or osmotic pressure). In some embodiments, the fluid comprises an element such as sodium chloride. In some embodiments, the fluid comprises an element such as magnesium chloride. In some embodiments, the fluid comprises a plurality of elements to maintain osmolality.

In some embodiments, the fluid comprises an element to maintain osmolality in a range from about 0.1 mOSM/kg to about 10,000 mOSM/kg. In some embodiments, the fluid comprises an element to maintain osmolality in a range from about 100 mOSM/kg to about 5,000 mOSM/kg. In some embodiments, the fluid comprises an element to maintain osmolality in a range from about 500 mOSM/kg to about 2,000 mOSM/kg. In some embodiments, the fluid comprises an element to maintain osmolality in a range from about 1000 mOSM/kg. In some embodiments, the fluid comprises an element to maintain osmolality in a range from about 100 mOSM/kg to about 500 mOSM/kg. In some embodiments, the fluid comprises an element to maintain osmolality in a range from about 200 mOSM/kg to about 400 mOSM/kg. In some embodiments, the fluid comprises an element to maintain osmolality in a range from about 260 mOSM/kg to about 320 mOSM/kg. In some embodiments, the osmolality (or osmotic pressure) is in a range as described by https://www.intechopen.com/books/biomedical-tissue-culture/culture-conditions-and-types-of-growth-media-for-mammalian-cells, the contents of which is hereby incorporated by reference in its entirety.

### Growth Factors

Among other things, the present disclosure describes methods, systems, and/or devices that comprise a fluid comprising a growth factor. In some embodiments, the fluid comprises a growth factor such as FGF. In some embodiments, the fluid comprises a growth factor such as TGF-b. In some embodiments, the fluid comprises a plurality of growth factors. In some embodiments, the fluid comprises growth factors such as epithelial and endothelial growth factors, vascular endothelial growth factors, platelet derived endothelial growth factors, epithelial growth factors, hepatocyte growth factors, and mixtures thereof.

In some embodiments, the fluid comprises a growth factor in an amount from about 1 fg/mL to about 10 g/mL. In some embodiments, the growth factor is in an amount as described by https://www.intechopen.com/books/biomedical-tissue-culture/culture-conditions-and-types-of-growth-media-for-mammalian-cells, the contents of which is hereby incorporated by reference in its entirety.

### Gasses

Among other things, the present disclosure describes methods, systems, and/or devices that comprise a fluid comprising a gas. In some embodiments, the fluid comprises a gas such as oxygen. In some embodiments, the fluid comprises a gas such as nitrogen. In some embodiments, the fluid comprises a gas such as hydrogen. In some embodiments, the fluid comprises a gas such as air. In some embodiments, the fluid comprises a plurality of gasses.

In some embodiments, the fluid comprises a gas in an amount from about 0.001 mg of gas/L to about 100 mg of gas/L. In some embodiments, the fluid comprises oxygen in an amount from about 0.001 mg of O2/L to about 100 mg of O2/L.

In some embodiments, the fluid lacks excess carbon dioxide. In some embodiments, the fluid has been degassed to remove excess carbon dioxide. In some embodiments, the systems and methods comprise vigorously aerating the fluid (e.g., with a pump). In some embodiments, degassing techniques are described by https://www.fdacs.gov/Consumer-Resources/Recreation-and-Leisure/Aquarium-Fish/Aquarium-Water-Quality-Carbon-Dioxide, the contents of which is hereby incorporated by reference in its entirety.

In some embodiments, a gas is sparged into a fluid prior to perfusion of the one of more fish. In some embodiments, a gas is sparged into a fluid during perfusion of the one of more fish.

### Organic Compounds

Among other things, the present disclosure describes methods, systems, and/or devices that comprise a fluid comprising an organic compound. In some embodiments, the fluid comprises an organic compound such as amino acids. In some embodiments, the fluid comprises insulin, L-Alanine, L-Arginine, L-Asparagine, L-Aspartic Acid, L-Cysteine, L-Cysteine, L-Glutamic Acid, L-Glutamine, L-Histidine, L-Isoleucine, L-Leucine, L-Lysine, L-Methionine, L-Phenylalanine, L-Proline, L-Serine, L-Threonine, and any combination thereof.

In some embodiments, the fluid comprises an organic compound such as fatty acids. In some embodiments, fatty acids include oleic acid, linoleic acid, palmitic, stearic acid, myristic acid, lauric acid, eicosapentaenoic acid, docosahexaenoic acid, and combinations thereof. In some embodiments, the fluid comprises an organic compound such as a carbohydrate. In some embodiment, the fluid comprises an organic compound such as a carbohydrate for cellular metabolism. In some embodiments, the fluid comprises a plurality of organic compounds.

In some embodiments, the fluid comprises an organic compound in an amount from about 1 fg/mL to about 10 g/mL. In some embodiments, the fluid comprises an organic compound in an amount from about 1 pg/mL to about 10 mg/mL. In some embodiments, the fluid comprises an organic compound in an amount from about 1 µg/mL to about 1 g/mL.

### Salts

Among other things, the present disclosure describes methods, systems, and/or devices that comprise a fluid comprising a salt. In some embodiments, the fluid comprises a salt such as sodium chloride. In some embodiments, the fluid comprises a salt such as potassium chloride. In some embodiments, the fluid comprises a salt such as calcium chloride. In some embodiments, the fluid comprises a salt such as calcium sulfate. In some embodiments, the fluid comprises a salt such as sodium bicarbonate. In some embodiments, the fluid comprises a plurality of salts.

In some embodiments, the fluid comprises a salt in an amount from about 0.001 g/L to about 1000 g/L. In some embodiments, the fluid comprises a salt in an about from about 0.01 g/L to about 100 g/L. In some embodiments, the fluid comprises a salt in an about from about 0.1 g/L to about 100 g/L. In some embodiments, the fluid comprises a salt in an about from about 1 g/L to about 100 g/L. In some embodiments, the fluid comprises a salt in an about from about 1 g/L to about 50 g/L. In some embodiments, the fluid comprises a salt in an about from about 1 g/L to about 25 g/L. In some embodiments, the fluid comprises a salt in an about from about 5 g/L to about 10 g/L. In some embodiments, the fluid comprises a salt in an about from about 1 g/L to about 9 g/L. In some embodiments, the fluid comprises a salt in an about from about 1 g/L to about 10 g/L. In some embodiments, the fluid comprises a salt in an about from about 0.1 g/L to about 0.5 g/L. In some embodiments, the fluid comprises a salt in an about from about 0.05 g/L to about 0.25 g/L. In some embodiments, the fluid comprises a salt in an about from about 0.1 g/L to about 0.3 g/L.

In some embodiments, the fluid comprises sodium chloride in an amount from about 5 g/L to about 10 g/L. In some embodiments, the fluid comprises sodium chloride in an amount of about 8 g/L.

In some embodiments, the fluid comprises calcium sulfate in an amount of about 125 mg/L to about 250 g/L

In some embodiments, the fluid comprises sodium bicarbonate in an amount of about 100 mg/L to about 200 mg/L.

In some embodiments, the fluid comprises a salt such as described by https://freshwater-aquaculture. extension. org/wp-content/uploads/2019/08/UsingSalt.pdf, the contents of which is hereby incorporated by reference in its entirety. In some embodiments, the fluid comprises a salt in an amount as described by https://freshwater-aquaculture.extension.org/wp-content/uploads/2019/08/UsingSalt.pdf, the contents of which is hereby incorporated by reference in its entirety.

### Thickening Agents

Among other things, the present disclosure describes methods, systems, and/or devices that comprise a fluid comprising a thickening agent. In some embodiments, the fluid comprises a thickening agent such as polyvinyl alcohol (PVA). In some embodiments, the fluid comprises a thickening agent such as polyvinylpyrrolidone (PVP). In some embodiments, the fluid comprises a plurality of thickening agents. In some embodiments, the fluid comprises a thickening agent such as polyethylene glycol (PEG). In some embodiments, the fluid comprises a thickening agent such as methyl cellulose.

In some embodiments, the fluid comprises a thickening agent in an amount from about 0.001% to about 99%. In some embodiments, the fluid comprises a thickening agent in an amount from about 0.001% to about 50%. In some embodiments, the fluid comprises a thickening agent in an amount from about 0% to about 20%. In some embodiments, the fluid comprises a thickening agent in an amount from about 0% to about 10%. In some embodiments, the fluid comprises a thickening agent in an amount from about 0% to about 5%.

In some embodiments, the fluid comprises PVP in an amount from about 0% to about 10%. In some embodiments, the fluid comprises PVP in an amount of about 0%, 2%, 4%, 6%, 8%, 9%, or 10%. In some embodiments, the fluid comprises PVP in an amount as described by Steven Denniss and James Rush “Polyvinylpyrrolidone can be Used to Cost-Effectively Increase the Viscosity of Culture Media” (published online 1 Apr. 2015 in the FASEB Journal) (https://www.fasebj.org/doi/abs/10.1096/fasebj.29.1_supplement.1029.19), the contents of which is hereby incorporated by reference in its entirety.

In some embodiments, the fluid comprises methyl cellulose in an amount from about 0% to about 10%. In some embodiments, the fluid comprises methyl cellulose in an amount from about 0% to about 5%. In some embodiments, the fluid comprises methyl cellulose in an amount from about 1% to about 2%. In some embodiments, the fluid comprises methyl cellulose in an amount from about 0% to about 2%. In some embodiments, the fluid comprises methyl cellulose in an amount from about 0.5% to about 1%. In some embodiments, the fluid comprises methyl cellulose in an amount as described by https ://www. sigmaaldrich. com/content/dam/sigmaaldrich/docs/Sigma/Product_Information_Sheet/2/m0512pis.pdf, the contents of which is hereby incorporated by reference in its entirety. In some embodiments, the fluid comprises methyl cellulose in an amount as described by https ://www. sigmaaldrich. com/content/dam/sigmaaldrich/docs/Sigma/Product_Information_Sheet/2/m0512pis.pdf, the contents of which is hereby incorporated by reference in its entirety.

### Vitamins

Among other things, the present disclosure describes methods, systems, and/or devices that comprise a fluid comprising a vitamin. In some embodiments, the fluid comprises a vitamin such as Vitamin A. In some embodiments, the fluid comprises a vitamin such as Vitamin C. In some embodiments, the fluid comprises a vitamin such as Vitamin B12. In some embodiments, the fluid comprises a vitamin such as partial polyoxometalates calcium. In some embodiments, the fluid comprises a vitamin such as choline chloride. In some embodiments, the fluid comprises a vitamin such as folic acid. In some embodiments, the fluid comprises a vitamin such as inositol. In some embodiments, the fluid comprises a vitamin such as pyridoxine. In some embodiments, the fluid comprises a vitamin such as riboflavin. In some embodiments, the fluid comprises a vitamin such as thiamine. In some embodiments, the fluid comprises a plurality of vitamins.

In some embodiments, the fluid comprises a vitamin in an amount from about 0.001 mg/L to about 1000 mg/L. In some embodiments, the fluid comprises a vitamin in an amount from about 1 µg/L to about 100 mg/L. In some embodiments, the fluid comprises a vitamin in an amount from about 10 µg/L to about 50 mg/L. In some embodiments, the fluid comprises a vitamin in an amount from about 50 µg/L to about 100 µg/L. In some embodiments, the fluid comprises a vitamin in an amount from about 50 µg/L to about 10 mg/L. In some embodiments, the fluid comprises a vitamin in an amount of about 90 µg/L. In some embodiments, the fluid comprises a vitamin in an amount of about 1 mg/L. In some embodiments, the fluid comprises a vitamin in an amount of about 1 fM to about 10 M.

In some embodiments, the fluid comprises Vitamin A in an amount of about 90 µg/L. In some embodiments, the fluid comprises Vitamin E in an amount of about 1 mg/L.

In some embodiments, the fluid comprises a vitamin in an amount as described by https://www.intechopen.com/books/biomedical-tissue-culture/culture-conditions-and-types-of-growth-media-for-mammalian-cells, the contents of which is hereby incorporated by reference in its entirety.

### Ions

Among other things, the present disclosure describes methods, systems, and/or devices that comprise a fluid comprising an ion. In some embodiments, the fluid comprises an ion such as Na+. In some embodiments, the fluid comprises an ion such as Cl2-. In some embodiments, the fluid comprises an ion such as H+. In some embodiments, the fluid comprises an ion such as K+. In some embodiments, the fluid comprises an ion such as Mg2+. In some embodiments, the fluid comprises an ion such as Ca2+. In some embodiments, the fluid comprises a plurality of ions.

In some embodiments, the fluid comprises an ion in an amount from about 0.1 mM to about 1000 mM. In some embodiments, the fluid comprises an ion in an amount as described by http://book.bionumbers.org/what-are-the-concentrations-of-different-ions-in-cells/, the contents of which is hereby incorporated by reference in its entirety.

In some embodiments, the fluid comprises an ion in an amount from about 0.1 mM to about 500 mM. In some embodiments, the fluid comprises an ion in an amount from about 1 mM to about 500 mM. In some embodiments, the fluid comprises an ion in an amount from about 10 mM to about 300 mM. In some embodiments, the fluid comprises an ion in an amount from about 10 mM to about 100 mM.

### ATP

Among other things, in some embodiments, the present invention provides for restoring of organ viability that may be accomplished by restoring high energy nucleotide (e.g., adenosine triphosphate (ATP)) levels and enzyme levels in the organ which were reduced by warm ischemia time and/or hypoxia.

In some embodiments, ATP is produced using a substrate such as phosphocreatine, creatine ethyl ester, dicreatine malate, creatine gluconate, fructose, sucrose, ribose, hexose, pentose, creatine orotate, creatine monohydrate, adenosine, dextrose/glucose, Dichloroacetate, malate, fumarate or pyruvate.

Among other things, in some embodiments, the fluid comprises energy substrates to replenish the intracellular ATP energy pool. For example, the present disclosure provides for aerobic metabolism during the perfusion and preservation process; antioxidants and/or xanthine oxidase inhibitors to mitigate reperfusion injury due to the free oxygen radicals.

In some embodiments, the fluid comprises ATP in an amount from about 1 fM to about 10 M. In some embodiments, the fluid comprises ATP in an amount from about 0.1 mM to about 100 mM. In some embodiments, the fluid comprises ATP in an amount from about 0.1 mM to about 50 mM. In some embodiments, the fluid comprises ATP in an amount from about 0.5 mM to about 10 mM.

### Cofactors

Among other things, the present disclosure describes methods, systems, and/or devices that comprise a fluid comprising a cofactor. In some embodiments, the fluid comprises a cofactor such as NADH. In some embodiments, the fluid comprises a cofactor such as NADPH. In some embodiments, the fluid comprises a cofactor such as thiamine HCl. In some embodiments, the fluid comprises a cofactor such as biotin. In some embodiments, the fluid comprises a cofactor such as a vitamin as described herein. In some embodiments, the fluid comprises a plurality of cofactors.

In some embodiments, the fluid comprises a cofactor in an amount from about 0.001 mg/L to about 1000 mg/L. In some embodiments, the fluid comprises a cofactor in an amount from about 1 µg/L to about 100 mg/L. In some embodiments, the fluid comprises a cofactor in an amount from about 10 µg/L to about 50 mg/L. In some embodiments, the fluid comprises a cofactor in an amount from about 50 µg/L to about 100 µg/L. In some embodiments, the fluid comprises a cofactor in an amount from about 50 µg/L to about 10 mg/L. In some embodiments, the fluid comprises a cofactor in an amount of about 90 µg/L. In some embodiments, the fluid comprises a cofactor in an amount of about 1 mg/L. In some embodiments, the fluid comprises a cofactor in an amount of about 1 fM to about 10 M.

In some embodiments, the fluid comprises a cofactor in an amount as described by https://www.intechopen.com/books/biomedical-tissue-culture/culture-conditions-and-types-of-growth-media-for-mammalian-cells, the contents of which is hereby incorporated by reference in its entirety.

### Buffers

Among other things, the present disclosure describes methods, systems, and/or devices that comprise a fluid comprising a buffer or a combination of buffers as provided herein. In some embodiments, the buffer comprises phosphate buffered saline (PBS). In some embodiments, the buffer comprises from about 0.1 % to about 99% (e.g., 0. 1% of HEPES [v/v with water]). In some embodiments, the buffer comprises 2% of HEPES, 96% of Sodium Bicarbonate, and 2% water. In some embodiments, the buffer comprises a buffer such as described by https://www.intechopen.com/books/biomedical-tissue-culture/culture-conditions-and-types-of-growth-media-for-mammalian-cells, the contents of which is hereby incorporated by reference in its entirety. In some embodiments, the buffer comprises a buffer such as described by http://www.endmemo.com/chem/massmolarconcentration.php, the contents of which is hereby incorporated by reference in its entirety.

### Enzymes

Among other things, the present disclosure describes methods, systems, and/or devices that comprise a fluid comprising an enzyme. In some embodiments, the fluid comprises an enzyme such as phosphokinase. In some embodiments, the fluid comprises a substrate such as phosphocreatine. In some embodiments, the fluid comprises an enzyme such as NAD kinase. In some embodiments, the fluid comprises an enzyme such as Polyphosphate-AMP phosphotransferase (PAP). In some embodiments, the fluid comprises an enzyme such as polyphosphate kinase (PPK). In some embodiments, the fluid comprises an enzyme such as Phosphoenolpyruvate (PEP). In some embodiments, the fluid comprises a substrate such as pyruvate. In some embodiments, the fluid comprises an enzyme such as pyruvate kinase. In some embodiments, the fluid comprises an enzyme for ATP regeneration. In some embodiments, the fluid comprises an enzyme for NADPH regeneration. In some embodiments, the fluid comprises an enzyme for generation of a cofactor described herein. In some embodiments, the fluid comprises a combination of enzymes. In some embodiments, the fluid comprises an enzyme such as creatine kinase.

In some embodiments, the fluid comprises an enzyme in an amount from about 1 fM to about 1 M. In some embodiments, the fluid comprises an enzyme in an amount as described by Love et al., “NAD kinase controls animal NADP biosynthesis and is modulated via evolutionarily divergent calmodulin-dependent mechanisms” first published on Jan. 20, 2015 in the Proceedings of the National Academy of Science of the United States of America, the contents of which is hereby incorporated by reference in its entirety. In some embodiments, the fluid comprises an enzyme in an amount as described by https://en.wikipedia.org/wiki/Creatine_kinase, the contents of which is hereby incorporated by reference in its entirety. In some embodiments, the fluid comprises an enzyme in an amount as described by Kameda et al., “A novel ATP regeneration system using polyphosphate-AMP phosphotransferase and polyphosphate kinase,” Journal of Bioscience and Bioengineering, Volume 91, Issue 6, 2001, pages 557-563, the contents of which is hereby incorporated by reference in its entirety.

### Use

In some embodiments, a fluid allows fish tissue and/or cells to stay alive for an extended period of time, e.g., for 5 minutes, e.g., 30 minutes, e.g., 1 day, e.g., 1 week, e.g., 1 month, e.g., 6 months, e.g., for 1 year, e.g., greater than a year. In some embodiments, an extended shelf life of live fish tissue can be used in a variety of industries and purposes. For example, in some embodiments, the present disclosure provides that increasing shelf life of material derived from a fish allows a wider window of time for supply chain logistics.

Among other things, the present disclosure provides for systems, methods, devices, and fluids that can be used in cellular agriculture. For example, in some embodiments, a fish can be acquired from its natural habitat and materials derived from the fish (e.g., fish cells, tissues, and/or organs) can be used in a laboratory setting for cellular agricultural purposes. In some embodiments, for example, a fish can be acquired from its natural habitat and materials derived from the fish can be exposed to (or contacted with or stored in) a fluid to allow the derived materials to stay alive for an extended period of time. In some embodiments, for example, a fish can be acquired from its natural habitat and materials derived from the fish can be exposed to (or contacted with or stored in) a fluid to allow the derived materials to stay alive for an extended period of time for a purpose described herein (e.g., for later use in a laboratory setting for cellular agricultural purposes). Among other things, in some embodiments, materials derived from a fish are stored in a container (e.g., a sealed container) for preserving cell viability during transport.

Among other things, in some embodiments, live cells from fish tissues could be isolated by researchers that are studying fish cell biology.

Among other things, the present disclosure provides that the systems, methods, devices, and fluids can be used in fish transporting companies.

Among other things, the present disclosure provides that the systems, methods, devices, and fluids can be used in food industry. Examples of food industries include fast food industries, fine dining, mom and pop stores, restaurants, cafeterias, prison, airline industries, schools, and the like.

Among other things, the present disclosure provides that systems, methods, devices, and fluids can be used in seafood distribution industries. Among other things, the present disclosure provides that systems, methods, devices, and fluids can be used in wholesaler industries.

### Types of Sterilization

In some embodiments, the present disclosure provides that the systems, methods, devices, and fluids can be sterilized or substantially sterilized. Examples of sterilization techniques include autoclaving, filtering (e.g., using tangential flow, polyethersulfone (PES), polyvinylidene fluoride (PVDF), or nylon), using ultraviolet light, antibiotics, or antimycotics.

### Computing Environment

As shown in FIG. 4, an implementation of a network environment 400 for use in providing systems, methods, and architectures for retrieving, managing, and analyzing live fish tissue preservation data from a plurality of sources as described herein is shown and described. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

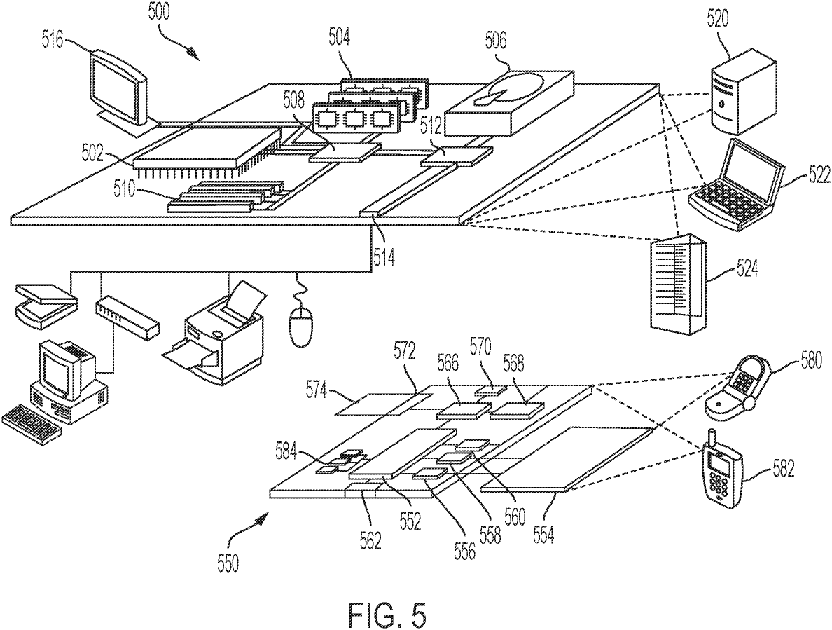

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the modules (e.g. data aggregation module 130, mapping module 150, specifications module 170) described herein can be separated, combined or incorporated into single or combined modules. The modules depicted in the figures are not intended to limit the systems described herein to the software architectures shown therein.

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein. In view of the structure, functions and apparatus of the systems and methods described here, in some implementations.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

While the invention has been particularly shown and described with reference to specific preferred embodiments, it should be understood by those skilled in the art that various changes in form and detail may be made therein without departing from the spirit and scope of the invention as defined by the appended claims.

### EXEMPLIFICATION

### Example 1

The present Example demonstrates systems, methods, compositions, and/or devices for transporting and/or preserving live fish tissue and/or preventing tissue damage.

### Exemplary Protocol

The present Example provides exemplary systems, compositions, methods, and/or devices for transporting and/or preserving live fish tissue and/or preventing tissue damage. It is noted that the term “fish” can refer to a single or multiple (or “array of”) fish.

For example, after a fish has been incapacitated via damage to its brain or by other means described herein, a needle is introduced into the heart and/or circulatory system of the fish. Afterwards, a fluid mixture is introduced into the circulatory system of the fish using a system of pumps. The fluid mixture supplies every tissue of the fish with nutrients and gasses in order to keep the fish alive while the brain is no longer functioning. The spent fluid is then pulled out of the body of the fish via another needle that is introduced into the atrium and threaded through the sinus venosus. The present Example further provides an exemplary protocol of making and using the described systems, methods, and/or devices for transporting and/or preserving live fish tissue and/or preventing tissue damage.

### 1. Obtain One or More Live Fish

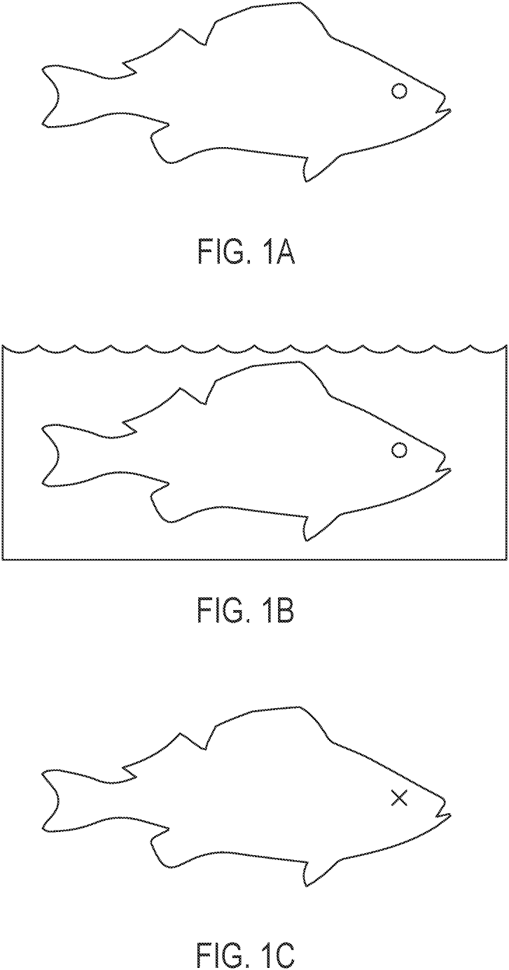

Among other things, the present Example provides for obtaining one or more live fish. First, one or more live fish (see FIG. 1A) is obtained. Live fish can include teleosts, primitive bichirs, sturgeons, paddlefish, freshwater garfishes, bowfins, or other fish known in the art. For example, a person having ordinary skill in the art would understand that other types of fish can be preserved using the methods and systems described herein.

### 2. Cool Fish to Reduce Stress

Among other things, the present Example provides for cooling one or more fish to preserve live fish tissue. After obtaining fish, fish are cooled to reduce stress experienced by the fish (see FIG. 1B). For example, fish can be cooled to a temperature from about -4 to about 20° C. to reduce stress experienced by the fish. In some embodiments, fish can be cooled by placing fish in an ice bath (e.g., having a temperature from about -4 to about 20° C.). Fish can also be cooled by placing fish in an ice-water slurry bath (e.g., having a temperature from about -4 to about 20° C.). In some embodiments, the ice-water bath has a percentage of ice by weight from about 0.1% to about 99.9%. Types of ice can include crushed, cubed ice, shaved ice, flake(s) of ice, pear ice, or crescent ice. Fish can also be cooled by placing fish in a cool water bath (e.g., having a temperature from about -4 to about 20° C.). Fish can also be cooled by placing fish in a refrigerator (e.g., having a temperature from about -4 to about 20° C.). A person of ordinary skill in the art would understand that other systems and methods can be used to cool fish to a temperature from about -4 to about 20° C.

### 3. Cool Fish to a Specific Temperature

Among other things, the present Example provides for cooling one or more fish to a specific temperature to preserve live fish tissue. For example. fish are then cooled to a specific temperature, e.g., any temperature from about -4 to about 20° C., or any temperature in between (see FIG. 1C).

### 4. Optionally Incapacitate Fish

Among other things, the present Example provides for optionally incapacitating one or more fish to preserve live fish tissue. In some embodiments, after cooling fish to a specific temperature as described herein, fish are optionally incapacitated (see FIG. 1C). Exemplary methods of incapacitation include asphyxiation, an ice bath, decapitation, one or more blows to the head, pithing, ikejime, poisoning, or electricity. A person having ordinary skill in the art would understand that other methods of incapacitation can be used with the systems and methods described herein.

Exemplary methods of decapitation include using a knife, using a hydraulic press attached to a sharp edge, or a saw (e.g., a circular saw or a reciprocating saw). A person having ordinary skill in the art would understand that other methods of decapitation can be used with the systems and methods described herein.

Blows to the head can be performed using a hammer or axe. Exemplary hammers include ball peen hammer, claw hammer, club hammer, dead blow hammer, framing hammer, sledge hammer, tack hammer, brick hammer, electricians hammer, engineering hammer, rock hammer, scotch hammer, shingle hammer, spike maul hammer, soft-faced hammer, toolmakers hammer, welding hammer, or power hammer (e.g., steam-powered hammer, electrical power hammer, air powered hammer). Exemplary axes include felling axes, hatchets, throwing tomahawks, splitting axes, double bit axes, Viking/dane axes, tactical axes, battle axes, hewing axes, adze axes, carpenters axes, fireman’s axes, crash axes, or throwing axes. Exemplary hammers and/or axes can comprise a material such as rubber, metal, plastic, wooden, brass or copper. A person having ordinary skill in the art would understand that other methods of blows to the head can be used with the systems and methods described herein.

Pithing is a technique that can be used to immobilize or kill an animal (such as fish) by inserting a needle or rod into an area of the animal. Pithing can be performed using a material such as metal, rubber, plastic, wood, brass, copper, or carbon fiber. In some embodiments, the pithing material is from about 1 mm in diameter to about 15 cm in diameter. The area that is pithed can include the brain (e.g., olfactory lobe, telencephalon, optic lobe, cerebellum, myelencephalon), spinal cord, heart or gills of the fish.

Ikejime is another method by which fish can be incapacitated. First, fish are pithed as described herein. Second, gills of the fish are cut. Gills can be cut at the base of the gills, the top of the gills near the front of the fish, or the middle of the gills. Gills can be cut using a knife, scissors, an axe, or a jigsaw using a material as described herein and/or using power such as electricity, human strength, steam power, or gas power. Third, a tail of the fish are cut. A tail can be cut at the base of the caudal fin, 20 cm out from the Caudal fin, or anywhere in between. A tail can be cut using a knife, scissors, axe, or jigsaw using a material as described herein and/or using power such as electricity, human strength, steam power, or gas power. Fourth, the spinal cord of the fish is destroyed. The spinal cord of the fish can be destroyed at the port of entry (e.g., any cut/opening on the posterior side of the fish, any cut/opening on the posterior side of the fish, or any cut/opening on the anterior side of the fish). The spinal cord can be destroyed using a utensil having a material described herein. The utensil can be powered by electricity, human strength, steam power or gas power. Fifth, the fish is bled. Fish can be bled at room temperature or at a temperature from about -4 to about 20° C. In some embodiments, fish are placed in an ice bath, ice-water slurry bath, cold water bath, refrigerator, or in open air. In some embodiments, the ice bath, ice-water slurry bath, cold water bath, refrigerator, or in open air has a temperature from about -4 to about 20° C. In some embodiments, ice-water slurry bath has a percentage of ice by weight of about 0.1% to about 99.9%. Types of ice in the ice-water slurry bath can include crushed ice, cubed ice, shaved ice, flake(s) of ice, pear ice, or crescent ice. Sixth, fish are optionally cauterized at any opening that may expel fluid. For example, fish can be poisoned by being immersed in water saturated with carbon dioxide (e.g., where carbon dioxide levels in water are greater than 5 mg/L as described by https://www.fdacs.gov/Consumer-Resources/Recreation-and-Leisure/Aquarium-Fish/Aquarium-Water-Quality-Carbon-Dioxide, the contents of which are hereby incorporated by reference herein in its entirety). As another example, fish can be poisoned by being exposed to MS22 as described by https://en.wikipedia.org/wiki/Tricaine_mesylate, the contents of which are hereby incorporated by reference herein in its entirety. Fish can also be cauterized by electricity. A person having ordinary skill in the art would understand that different types of cauterization techniques could be employed.

### 5. Introduce Fluid Into Circulatory System of Fish

Among other things, the present Example also describes that fluid is introduced into the circulatory system of the fish through one of the methods to preserve live fish tissue (See FIG. 2A). The fluid can be flowed at a rate from about 1 nL per minute to about 1 L per minute, or at any rate in between. The fluid can be at a temperature from about -1 to about 20° C., or any temperature in between.

The present Example provides for a variety of needles that can be used according to the methods described herein. In some embodiments, the needle has a NeedlePoint style such as 2, 3, 3T, 4 (at 1 degree through 90 degrees), 5, AS. In some embodiments, the needle has a needle gauge of 7, 8, 9, 10, 11, 12, 13, 14, 15, 16, 17, 18, 19, 20, 21, 22, 23, 24, 25, 26, 27, 28, 29, 30, 31, 32, or 33. The needle can be comprised of medical grade stainless steel, Advanced alloys, exotic metals, MRI compatible materials, or Polymers. A person having ordinary skill in the art would understand that other types of needles could be used in accordance with the systems and methods described herein.

The present Example also provides methods for introducing fluid into the circulatory system by placing one or more needles into the heart of the fish. While the present Example describes placement into the heart, a person having ordinary skill in the art would understand that needles can also be placed into other organs of the circulatory system. Exemplary organs include hepatic vein, portal veins, caudal vein, caudal artery, dorsal aorta, mesenteric artery, hepatic artery, efferent gill arties, or afferent gill arteries.

### A. One Needle That is Introduced Into the Heart Pumping Fluid Into the Circulatory System

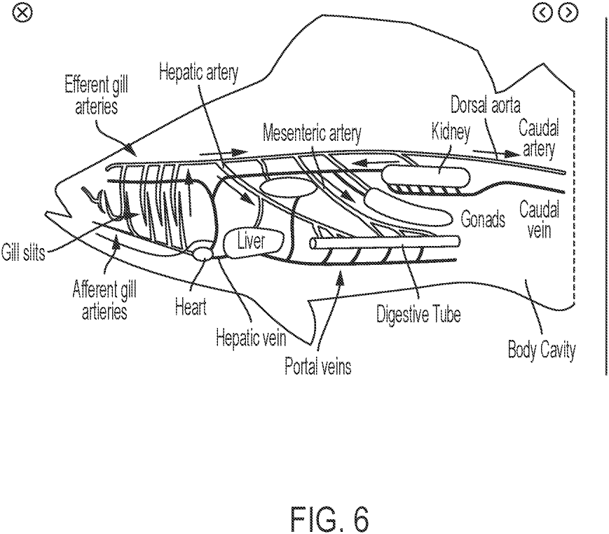

Among other things, the present Example also describes that a needle is introduced into the heart and is used to pump fluid into the circulatory system (see, e.g., FIG. 6).

The needle can be placed into a variety of positions within the chambers of the heart, and can be positioned such that it is in only one chamber of the heart. For example, in some embodiments, a needle is introduced into the Bulbus Arteriosus only and is used to pump fluid into the circulatory system. In some embodiments, a needle is introduced into the Ventricle only and is used to pump fluid into the circulatory system. In some embodiments, a needle is introduced into the Atrium only and is used to pump fluid into the circulatory system. In some embodiments, a needle is introduced into the Sinus Venosus only and is used to pump fluid into the circulatory system. In some embodiments, a needle is introduced into the into the Sinus Venosus only and is used to pump fluid into the circulatory system.

As another example, in some embodiments, a needle can be placed into a variety of positions within the chambers of the heart, and can be positioned such that it is in more than one chamber of the heart simultaneously (see, e.g., FIG. 6). For instance, in some embodiments, a needle is introduced Into the Bulbus Arteriosus and the head of the needle is introduced into the Ventricle. In some embodiments, a needle is introduced Into the Bulbus Arteriosus and the head of the needle is introduced into the Ventricle. In some embodiments, a needle is introduced into the Ventricle and the head of the needle is introduced into the Bulbus Arteriosus. In some embodiments, a needle is introduced into the Ventricle and the heard of the needle is introduced into the Atrium. In some embodiments, a needle is introduced into the Atrium and the head of the needle is introduced into the Ventricle. In some embodiments, a needle is introduced into the Atrium and the needle head is introduced into the Sinus Venosus. In some embodiments, a needle is introduced into the Sinus Venosus and the head of the needle is introduced into the Atrium.

### B. One Needle that is Introduced into the Heart Pumping Fluid into the Circulatory System and One Needle that is Introduced into the Heart Pumping Fluid Out of the Circulatory System

Among other things, the present Example also describes that a first needle is introduced into the heart for pumping fluid into the circulatory system, and a second needle is introduced into the heart for pumping out of the circulatory system. A needle can be shaped and sized for placement into the circulatory system as described herein.

The needles can be placed into a variety of positions within the chambers of the heart, and can be positioned such that both needles are in only one chamber of the heart. For example, in some embodiments, both needles are introduced into the Bulbus Arteriosus only. For example, in some embodiments, both needles are introduced into the Ventricle only. For example, in some embodiments, both needles are introduced into the Atrium only. For example, in some embodiments, both needles are introduced into the Sinus Venosus only.

Alternatively, in some embodiments, the needles can be placed into a variety of positions within the chambers of the heart, and can be positioned such that the first needle is positioned into a first chamber of the heart, and the second needle is positioned into a second chamber of the heart. For example, the first needle is placed into the Bulbus Arteriosus and the second needle is placed in the Ventricle. For example, the first needle is placed into the Ventricle and the second needle is placed in the Bulbus Arteriosus. For example, the first needle is placed into the Ventricle and the second needle is placed in the Atrium. For example, the first needle is placed into the Atrium and the second needle is placed in the Ventricle. For example, the first needle is placed into the Atrium and the second needle is placed in the Sinus Venosus. For example, the first needle is placed into the Sinus Venosus and the second needle is placed in Atrium.

### C. One Specially Designed Needle that is Introduced into the Heart That Allows Fluids to Be Simultaneously Pumped in and Out of the Heart

Among other things, the present Example also describes that a specially designed needle that is introduced into the heart that allows fluids to be simultaneously pumped in and out of the heart.

In such embodiments, the needle can be placed into a variety of positions within the chambers of the heart, and can be positioned such that it is in only one chamber of the heart. For example, in some embodiments, a needle is introduced into the Bulbus Arteriosus only and is used to pump fluid into the circulatory system. In some embodiments, a needle is introduced into the Ventricle only and is used to pump fluid into the circulatory system. In some embodiments, a needle is introduced into the Atrium only and is used to pump fluid into the circulatory system. In some embodiments, a needle is introduced into the Sinus Venosus only and is used to pump fluid into the circulatory system. In some embodiments, a needle is introduced into the Sinus Venosus only and is used to pump fluid into the circulatory system.

As another example, in some embodiments, a needle can be placed into a variety of positions within the chambers of the heart, and can be positioned such that it is in more than one chamber of the heart simultaneously. For instance, in some embodiments, a needle is introduced into the Bulbus Arteriosus and the head of the needle is introduced into the Ventricle. In some embodiments, a needle is introduced Into the Bulbus Arteriosus and the head of the needle is introduced into the Ventricle. In some embodiments, a needle is introduced into the Ventricle and the head of the needle is introduced into the Bulbus Arteriosus. In some embodiments, a needle is introduced into the Ventricle and the heard of the needle is introduced into the Atrium. In some embodiments, a needle is introduced into the Atrium and the head of the needle is introduced into the Ventricle. In some embodiments, a needle is introduced into the Atrium and the needle head is introduced into the Sinus Venosus. In some embodiments, a needle is introduced into the Sinus Venosus and the head of the needle is introduced into the Atrium.

### 6. Fluid is Pumped Through the Circulatory System Through a System of Tubes

Among other things, the present Example describes that fluid is pumped through the circulatory system of the fish through a system of tubes for the purpose of preserving live fish tissue. In some embodiments, for example, the back end of the needle attaches to a tube, and the tube is connected to a pump. Exemplary pumps include peristaltic pumps, lobe pumps, diaphragm pumps, or piston pumps. Exemplary tubes include: aluminum tubes, copper tubes, steel tubes, stainless steels tubes, nylon tubes, polyethylene tubes, polypropylene tubes, polyurethane tubes, PVC tubes, vinyl tubes, rubber tubing, or fiberglass or composite tubes. A person having ordinary skill in the art would understand that other types of pumps and/or tubes can be used with the systems and methods described herein.

### 7. Fluid Is Pumped Through the Circulatory System of One or More Fish

The present Example also describes that fluid is pumped through the circulatory system of one or more fish in order to preserve live fish tissue. For instance, the present Example describes a system that hooks up to one fish (e.g., see FIG. 2B). The present Example also describes a system that hooks up to many fish (e.g., see FIG. 2C).

### 8. Fluid Comprises Many Factors To Preserve Live Fish Tissue

Among other things, the present Example describes a fluid that comprises a variety of factors to preserve live fish tissue. For instance, the fluid described herein allows the fish to stay alive for a longer period of time. Exemplary factors include water, sugars, elements to balance pH, elements to maintain osmolality, growth factors, organic compounds, salts, thickening agents, vitamin, ions, ATP, cofactors, buffers, and enzymes. Examples of types of such factors are provided herein. A person having ordinary skill in the art would understand that other factors may also be used to preserve live fish tissue in accordance with the systems and methods described herein.

### 9. Movement Of Fluid Stays Within Closed System

Among other things, the present Example described that fluid moves within the closed system (see FIG. 3A). For example, in some embodiments, fluid is depleted from a first tank (Tank 1), perfused through the body of a fish (or multiple fish) and then accumulates into a second tank (Tank 2).

### 10. Fluid Allows Fish Tissue and/or Cells to Stay Alive for an Extended Period of Time

Among other things, the present Example also describes that contacting fluid with fish tissue and/or fish cells allows for fish tissue and/or cells to stay alive for an extended period of time. For instance, in some embodiments, contacting fluid with fish tissue and/or fish tissue can extend the life time of the fish tissue and/or cells for a time period from about 5 minutes to about one year, or any time in between.

### 11. Fluid Extends Shelf Life of Live Fish Tissue to Help Multiple Industries

Among other things, the present Example describes a fluid that extends shelf life of live fish tissue. Extending shelf life of live tissue is important to a variety of industries such as cellular agriculture, fish transporting companies, and the food industry. In the cellular agriculture industry, for example, it is important that the fish tissue and/or cells stay fresh from material acquisition from where the natural habitat of the fish is to transportation of the fish to a laboratory of a company. Increasing the shelf life of the material allows scientists more time to process the tissue. In addition, for fish transporting companies or the food industry, increasing the shelf life of fish material allows a wider window of time for companies supply chain logistics. Exemplary food industries include fast food industries, fine dining, mom and pop store, restaurants, cafeteria, prison, airline, schools, food distributors, and wholesalers.

### 12. The Described Systems Are Sterile or Close to Sterile.

Among other things, the present Example also provides for a closed system that is sterile or close to sterile that preserves live fish tissue. Types of sterilization are described herein. A person of ordinary skill in the art would understand that other methods for sterilization can be used.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

We claim:

1. A method of transporting and/or preserving live fish tissue and/or preventing tissue damage to live fish tissue, the method comprising:
contacting live fish tissue with a fluid via a needle having been placed into an organ of a circulatory system of one or more fish.

2. The method of claim 1, wherein the fluid comprises at least one member selected from the group consisting of water, sugars, elements to balance pH, elements to maintain osmolarity and/or osmolality, growth factors, gases, organic compounds, salts, thickening agents, vitamins, ions, ATP, cofactors, buffers, enzymes, and any combination thereof.

3. The method of claim 1 or 2, comprising
flowing the fluid at a first flow rate from about 1 nL per minute to about 1 L per minute (e.g., from about 10 nL per minute to about 500 mL per minute, e.g., from about 1 µL per minute to about 250 mL per minute, e.g., from about 100 µL per minute to about 10 mL per minute).

4. The method of any one of the preceding claims,
wherein the fluid flows from a first tank to perfuse the circulatory system to a second tank.

5. The method of any one of the preceding claims, wherein the contacting is carried out in one or more containers containing the live fish tissue.

6. The method of any one of the preceding claims, comprising keeping the live fish tissue and/or organ in contact with the fluid for at least an hour.

7. The method of any one of the preceding claims, comprising circulating the fluid through the tissue or the organ.

8. The method of any one of the preceding claims, comprising preserving live fish tissue and/or preventing tissue damage to live fish tissue stays fresh for an extended period of time (e.g., from about 5 minutes to about 1 year, e.g., from about 30 minutes to about 9 months, e.g., from about 7 days to about 6 months, e.g., from about 1 month to about 6 months, e.g., from about 2 months to about 6 months, e.g., from about 2 months to about 12 months).

9. The method of any one of the preceding claims, further comprising:
maintaining the circulatory system at a temperature from about -4° C. to about 20° C. (e.g., from about -4° C. to about 10° C., e.g., about -1° C.).

10. The method of any one of the preceding claims, further comprising:
removing blood from the circulatory system (e.g., using a saline solution).

11. The method of any one of the preceding claims,
wherein the fluid has a temperature from about -4° C. to about 20° C. (e.g., from about -4° C. to about 10° C., e.g., about -1° C.).

12. The method of any one of the preceding claims,
wherein the organ is or comprises a member selected from the group consisting of a heart, hepatic vein, portal vein, caudal vein, caudal artery, dorsal aorta, mesenteric artery, hepatic artery, efferent gill artery, and afferent gill artery.

13. The method of any one of the preceding claims,
wherein the organ is or comprises a heart.

14. The method of any one of the preceding claims,
wherein the organ is a heart and the composition is circulated throughout vasculature of the heart, preferably wherein the composition is circulated through all compartments of the heart.

15. The method of claim 13 or claim 14, wherein the first needle is placed into a first chamber of the heart (e.g., wherein the first chamber is or comprises a member selected from the group consisting of a bulbus arteriosus, a ventricle, an atrium, and a sinus venosus).

16. The method of claim 15, wherein the first needle is simultaneously placed into both a first chamber of the heart and a second chamber of the heart (e.g., wherein the first and second chamber is or comprises a member selected from the group consisting of a bulbus arteriosus, a ventricle, an atrium, and a sinus venosus).

17. The method of claim 15, wherein the first needle comprises a head, and wherein the head is placed into a second chamber of the heart.

18. The method of any one of the preceding claims, wherein the first needle simultaneously is adapted to flow the fluid into and out of the organ.

19. The method of any one of the preceding claims, the method comprising:
flowing the fluid, via the second needle having been placed into the organ of the circulatory system, out of the organ of the circulatory system at a second flow rate (e.g., into a second tank) (e.g., wherein the second flow rate is at a rate sufficiently similar to the first flow rate) (e.g., wherein the second flow rate is at a rate less than the first flow rate).

20. The method of claim 19, wherein the first needle and the second needle are placed in the first chamber of the heart (e.g., wherein the first chamber is or comprises a member selected from the group consisting of a bulbus arteriosus, ventricle, atrium, or sinus venosus).

21. The method of claim 20, wherein the first needle and the second needle are placed in the first chamber and the second chamber, respectively, of the heart (e.g., wherein the first and second chambers are different chambers).

22. The method of any one of the preceding claims, wherein the method comprises using a pump (e.g., a peristaltic pump, e.g., a lobe pump, e.g., a diaphragm pump, e.g., a piston pump) (e.g., in combination with flow rate sensors optionally with feedback-loop for online-control and real-time adjustment of the first flow rate).

23. The method of any one of the preceding claims, further comprising retrieving, managing, and/or analyzing live fish tissue preservation data, via a processor of a computing device.

24. A system for transporting and/or preserving live fish tissue and/or preventing tissue damage to live fish tissue, the system comprising:
a fluid for contacting live fish tissue; and
one or more containers adapted to receive one or more fish having a first needle placed into an organ or tissue of the one or more fish.

25. The system of claim 24, comprising:
a first tank adapted to store the fluid; and
a second tank adapted to receive the fluid;.

26. The system of claim 24 or 25, comprising one or more tubes (e.g., for introducing and/or removing the fluid to or from the live fish tissue).

27. The system of any one claims 24 to 26, wherein the fluid contacts the live fish tissue by flowing from the first tank through the live fish tissue and to the second tank.

28. The system of any one of claims 24 to 27, the system a second needle placed into an organ or tissue of the one or more fish.

29. The system of any one of claims 24 to 28, wherein the fluid comprises at least one member selected from the group consisting of water, sugars, elements to balance pH, elements to maintain osmolarity and/or osmolality, growth factors, gases, organic compounds, salts, thickening agents, vitamins, ions, ATP, cofactors, buffers, enzymes, and any combination thereof.

30. The system of any one of claims 24 to 29, the system comprising a pump.

31. The system of claim 30, wherein the pump is or comprises a member selected from the group consisting of a peristaltic pump, a lobe pump, a diaphragm pump, a piston pump, and any combination thereof.

32. The system of any one of claims 24 to 31, the system comprising one or more flow rate sensors.

33. The system of any one of claims 24 to 32, wherein the system is sterile or sufficiently sterile (e.g., wherein the one or more containers is sterile or sufficiently sterile, e.g., wherein the first needle is sterile or sufficiently sterile, e.g., wherein the first tank and the second tank are sterile or sufficiently sterile, e.g., wherein the second needle is sterile or sufficiently sterile, e.g., wherein the fluid is sterile or sufficiently sterile).

34. The system of any one of claims 24 to 33, wherein the one or more fish have a temperature from about -4° C. to about 20° C. (e.g., from about -4° C. to about 10° C., e.g., about -1° C.).

35. The system of any one of the claims 24 to 33, wherein a processor of the computing device is configured to retrieve, manage, and/or analyze live fish tissue preservation data.

36. A fluid suitable for contacting and/or perfusing and/or preserving, and/or storing live fish cells, tissues, or organs.

37. The fluid of claim 36, comprising at least one factor selected from the group consisting of water, sugars, elements to balance pH, elements to maintain osmolarity and/or osmolality, growth factors, gases, organic compounds, salts, thickening agents, vitamins, ions, ATP, cofactors, buffers, enzymes, and any combination thereof.

38. The fluid of claim 37, wherein each factor of the at least one factor is present in the fluid in an amount effective to prolong the viability of the fish cells, tissues, or organs when maintained substantially in the fluid, as compared to the maintenance of the fish cells, tissues, or organs stored in the fluid alone.

39. The fluid of any one of claims 36 to 38, wherein the fluid preserves and/or prevents damage to the live fish cells, tissues, and organs for an extended period of time (e.g., from about 5 minutes to about 1 year, e.g., from about 30 minutes to about 9 months, e.g., from about 7 days to about 6 months, e.g., from about 1 month to about 6 months, e.g., from about 2 months to about 6 months, e.g., from about 2 months to about 12 months) as compared to the maintenance and/or storage of the live fish tissue, cells, or organs maintained in water alone.

40. A device comprising a needle adapted for contacting and/or perfusing and/or storing live fish cells, tissues, or organs (e.g., of one or more incapacitated fish).

41. The device of claim 40, wherein the needle is placed into a first location (e.g., a chamber) of an organ of the circulatory system (e.g., wherein the first chamber is or comprises a member selected from the group consisting of a bulbus arteriosus, a ventricle, an Atrium, and a sinus venosus).

42. The device of claim 40 or 41, wherein the needle is simultaneously placed into both a first location of the organ and a second location of the organ.

43. The device of claim 42, wherein the first needle comprises a head, and wherein the head is placed into a second chamber of the heart.

44. The device of any one of claims 40 to 43, wherein the first needle simultaneously is adapted to flow the fluid into and out of the organ.

45. Live fish cells, tissues, or organs for use in transportation and/or preservation, wherein the fish tissue is stored in a fluid.
